(19) United States
(12) Patent Application Publication
(10) Pub. No.: US 2024/0224386 A1
(43) Pub. Date: Jul. 4, 2024

(54) COOKING APPLIANCE AND METHODS OF NOTIFICATION

(71) Applicant: Haier US Appliance Solutions, Inc., Wilmington, DE (US)

(72) Inventor: Kira Lynn Hartlage, Crestwood, KY (US)

(21) Appl. No.: 18/149,884

(22) Filed: Jan. 4, 2023

(51) Int. Cl. H05B 6/68; H05B 6/64

(52) U.S. Cl. CPC H05B 6/687; H05B 6/6408; H05B 6/6447

(57) ABSTRACT

A cooking appliance may include a cabinet, a door, a control panel, a microwave module, a support pan, a presence detection sensor, and a controller. The support pan may be mounted within the cooking chamber to receive food items thereon. The presence detection sensor may be directed at the support pan and configured to detect one or more food items on the support pan. The controller may be in operable communication with the presence detection sensor and the control panel. The controller may be configured to direct an appliance operation including detecting the door in an open position, evaluating the presence detection sensor, detecting the door in a closed position following evaluation of the presence detection sensor, and directing the control panel according to the evaluation in response to detecting the door in the closed position.

### FIELD OF THE INVENTION

The present subject matter relates generally to cooking appliances, such as microwave appliances, and more particularly to methods and systems for notifying a user from a cooking appliance.

### BACKGROUND OF THE INVENTION

Over the past several decades, relatively fast or small cooking appliances, such as microwave cooking appliances (i.e., microwave appliances), have become a staple appliance for many, if not most kitchens. Generally, such cooking appliances include a cabinet that defines a cooking chamber for receipt of food items for cooking. In order to provide selective access to the cooking chamber and to contain food items and cooking energy (e.g., microwaves) during a cooking operation, a door is further included that is typically pivotally mounted to the cabinet. In the case of a microwave appliance, a magnetron can generate the microwave radiation or microwaves that are directed specifically to the cooking chamber. The microwave radiation is typically able to heat and cook food items within the cooking chamber faster than would be possible with conventional cooking methods using direct or indirect heating methods. Additionally or alternatively, the relatively small size of items being cooked within small cooking appliance often leads to foods being rapidly heated.

The relatively fast heating of certain cooking appliances can often prompt a user to regularly check or test food items being cooked (e.g., in the middle of a cooking operation). For instance, it is common for a user to start a cooking operation for a set duration, but then interrupt the cooking operation (e.g., by opening the door) to check the temperature or state of food before the set duration has expired. Sometimes a user will decide that the food has been sufficiently heated. Nonetheless, most cooking appliances (e.g., operation) will generate repetitive or regular alerts any time a cooking operation is interrupted. This can be tedious and annoying for users, who must return to the cooking appliance and manually confirm that the cooking operation does not need to continue (e.g., by clearing the set duration).

As a result, it may be useful to provide a cooking appliance or method that can automatically (e.g., without direct user input) determine if an interrupted cooking operation should continue or a user's attention is needed. Additionally or alternatively, automatically tailored alerts that can account for a user's intervention may be advantageous.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cabinet, a door, a control panel, a microwave module, a support pan, a presence detection sensor, and a controller. The cabinet may define a cooking chamber. The door may be movably mounted to the cabinet to selectively restrict access to the cooking chamber. The control panel may be attached to the cabinet. The microwave module may be mounted within the cabinet. The microwave module may be positioned and configured for delivering microwave energy into the cooking chamber. The support pan may be mounted within the cooking chamber to receive food items thereon. The presence detection sensor may be directed at the support pan and configured to detect one or more food items on the support pan. The controller may be in operable communication with the presence detection sensor and the control panel. The controller may be configured to direct an appliance operation including detecting the door in an open position, evaluating the presence detection sensor, detecting the door in a closed position following evaluation of the presence detection sensor, and directing the control panel according to the evaluation in response to detecting the door.

In another exemplary aspect of the present disclosure, a method of operating a cooking appliance is provided. The method may include detecting a door of the cooking appliance in an open position. The method may also include evaluating a presence detection sensor. The method may further include detecting the door in a closed position following evaluation of the presence detection sensor. The method may still further include directing the control panel according to the evaluation in response to detecting the door.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a perspective view of the exemplary cooking appliance of FIG. 1, wherein the door is an open position.

FIG. 3 provides a sectional view of the exemplary cooking appliance of FIG. 2.

FIG. 4 provides a schematic sectional view of a bottom portion of a cooking appliance according to exemplary embodiments of the present disclosure.

FIG. 5 provides a schematic sectional view of a bottom portion and a turntable assembly of a cooking appliance according to exemplary embodiments of the present disclosure.

FIG. 6 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

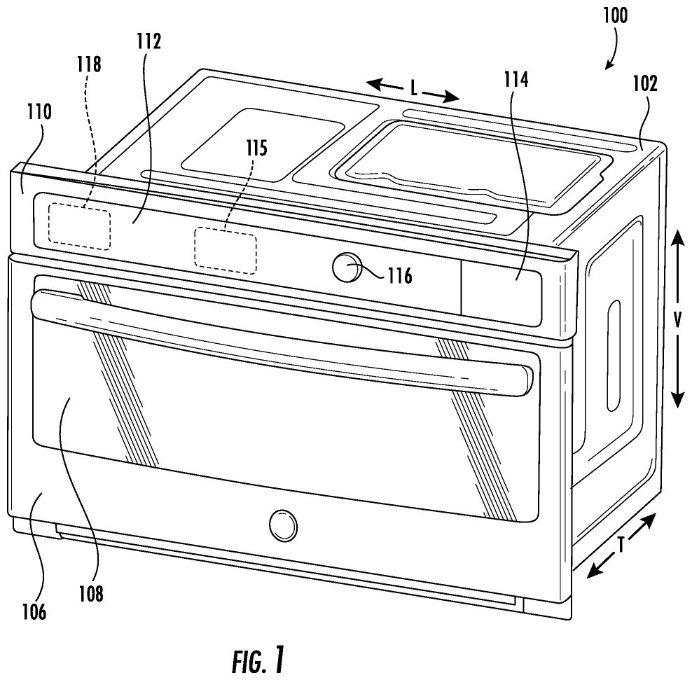

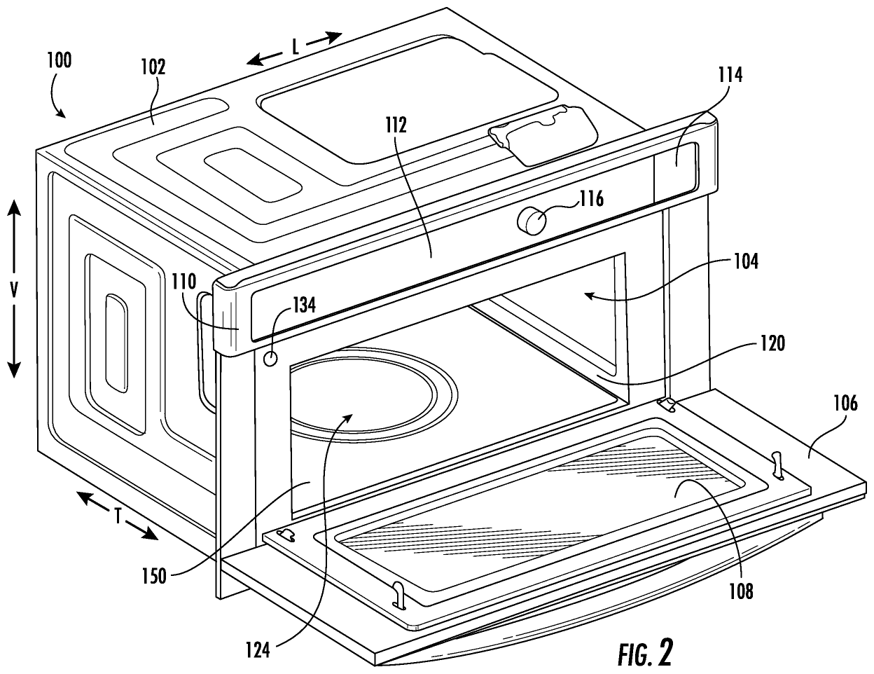

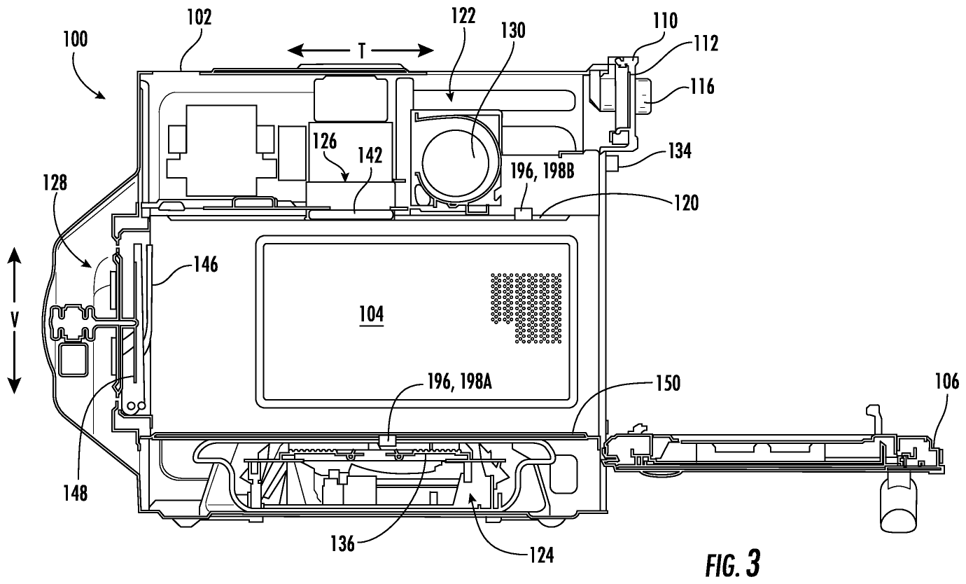

Turning now to the figures, FIGS. 1 through 3 provide various views of a cooking appliance 100 according to exemplary embodiments of the present disclosure. Specifically, FIGS. 1 and 2 provide perspective views of cooking appliance 100 having a door 106 in an open position and a closed position, respectively. FIG. 3 provides a side, sectional view of cooking appliance 100, wherein door 106 is in the open position.

Generally, cooking appliance 100 includes a housing or cabinet 102 that defines a mutually-orthogonal vertical direction V, lateral direction L, and transverse direction T. Within cabinet 102, cooking appliance 100 defines a cooking chamber 104 in which food items can be received. In some embodiments, a door 106 is rotatably mounted to move between the open position and the closed position. As shown, the open position permits access to cooking chamber 104 while the closed position restricts access to cooking chamber 104. A window in door 106 may be provided (e.g., for viewing food items in the cooking chamber 104). Additionally or alternatively, a handle may be secured to door 106 (e.g., to rotate therewith). The handle can be formed of plastic, for example, and can be injection molded.

In certain embodiments, cooking appliance 100 includes a control panel frame 110 on or as part of cabinet 102. A control panel 112 may be mounted within control panel frame 110. Generally, control panel 112 includes a display device 114 for presenting various information to a user. Control panel 112 may also include one or more input devices (e.g., tactile buttons, knobs, touch screens, etc.). In optional embodiments, the input devices of control panel 112 include a knob or dial 116. Selections may be made, for example, by rotating dial 116 clockwise or counterclockwise, and when the desired selection is displayed, pressing dial 116. For example, many meal cook cycles and other cooking algorithms can be preprogrammed in or loaded onto a memory device of a controller 118 of cooking appliance 100 for many different food items types (e.g., pizza, fried chicken, French fries, potatoes, etc.), including simultaneous preparation of a group of food items of different food types comprising an entire meal. Instructions or selections may be displayed on display device 114. In optional embodiments, display device 114 can be used as an input device. For instance, display device 114 may be a touchscreen device, as is understood.

Separate from or in addition to display device 114, control panel 112 may include one or more speaker elements 115. Such speaker elements 115 are generally understood and may include one or more magnetic or electrostatic diaphragms to generate one or predetermined sound notifications (e.g., recorded or artificially generated beeps, chirps, or voices) to audibly notify a user of one or more set conditions.

Cooking appliance may include a door sensor 134 in selective communication with the door 106. Additionally or alternatively, door sensor 134 may be provided at cabinet 102 proximate to door 106. Door sensor 134 may operate to sense a position of door 106 (e.g., a closed position or an open position). For instance, door sensor 134 may be configured to detect if or when door 106 is in a closed position. Generally, door sensor 134 may include or be provided as any suitable sensor, such as a contact sensor, a reed switch, a Hall effect sensor, an optic sensor, or the like. Optionally, door sensor 134 may be included with or as a part of a latch assembly configured to lock or otherwise hold the door 106 in the closed position, as would be understood.

In exemplary embodiments, cabinet 102 of cooking appliance 100 includes an inner shell 120. Inner shell 120 of cabinet 102 delineates the interior volume of cooking chamber 104. Optionally, the walls of shell may be constructed using high reflectivity (e.g., 72% reflectivity) stainless steel.

Generally, cooking appliance 100 includes at least one cooking modules. In optional embodiments, cooking appliance 100 includes multiple cooking modules. For instance, cooking appliance 100 may include a microwave module 122 and a lower heater module 124 mounted within cabinet 102. In additional or alternative embodiments, cooking appliance 100 includes an upper heater module 126 or a convection module 128.

The exemplary cooking appliance 100 described herein includes multiple different cooking modules and may, thus, be commonly described as a hybrid cooking appliance. Nonetheless, it is understood that although the exemplary cooking appliance 100 is described as a hybrid cooking herein includes multiple different cooking modules, such appliances are merely non-binding examples. As a result, the present disclosure is not limited to hybrid appliances and may encompass or be applicable to any other suitable cooking appliance, such as a stand-alone microwave appliance, toaster oven, air fryer, etc. that includes fewer (or more) cooking modules than cooking appliance 100.

In certain embodiments, microwave module 122 includes a magnetron 130 mounted within the cabinet 102 (e.g., above cooking chamber 104) and in communication (e.g., fluid or transmissive communication) with the cooking chamber 104 to direct microwave radiation or microwaves thereto. In other words, the microwave module 122 delivers microwave radiation into cooking chamber 104.

In additional or alternative embodiments, lower heater module 124 may be mounted within cabinet 102 (e.g., below microwave module 122). For instance, lower heater module 124 may include an induction heating coil 136 mounted below cooking chamber 104. As will be described in greater detail below, induction heating coil 136 may be in communication (e.g., transmissive communication) with cooking chamber 104 (e.g., through a one-way field filter 160) to direction a magnetic field 162 thereto.

Upper heater module 126 can include one or more heating elements 142. For instance, upper heater module 126 can include one or more electric heating elements, such as a resistive heating element (e.g., sheathed resistive heater) or a radiant heating element (e.g., a halogen cooking lamp) in thermal communication with cooking chamber 104. Upper heater module 126 may be mounted within or above cooking chamber 104 or otherwise spaced apart from microwave module 122.

Convection module 128 may include a sheathed heater 146 and a convection fan 148. Convection fan 148 is provided for blowing or otherwise moving air over sheathed heater 146 of convection module 128 and into cooking chamber 104 (e.g., for convection cooking).

The specific heating elements of upper and lower heater modules 126 and 124, convection module 128, and magnetron 130 of microwave module 122 can vary from embodiment to embodiment, and the elements and system described above are exemplary only. For example, the upper heater module 126 or convection module 128 can include any combination of heaters including combinations of halogen lamps, ceramic lamps, or sheathed heaters.

As shown, cooking appliance 100 may include a controller 118. Controller 118 of cooking appliance 100 can include one or more processor(s) and one or more memory device(s). The processor(s) of controller 118 can be any suitable processing device, such as a microprocessor, microcontroller, integrated circuit, or other suitable processing device. The memory device(s) of controller 118 can include any suitable computing system or media, including, but not limited to, non-transitory computer-readable media, RAM, ROM, hard drives, flash drives, or other memory devices. The memory device(s) of controller 118 can store information accessible by the processor(s) of controller 118 including instructions that can be executed by the processor(s) of controller 118 in order to execute various cooking operations or cycles (e.g., a meal cook cycle). Controller 118 is communicatively coupled with various operational components of cooking appliance 100, such as components of microwave module 122, upper heater module 126, lower heater module 124, convection module 128, or control panel 112 (e.g., display device 114 or dial 116), the various control buttons, etc. Input/output (“I/O”) signals may be routed between controller 118 and control panel 112 as well as other operational components of cooking appliance 100. Controller 118 can execute and control cooking appliance 100 in various cooking operations or cycles, such as precision cooking, which includes meal cook, microwave, induction, or convection/bake modes.

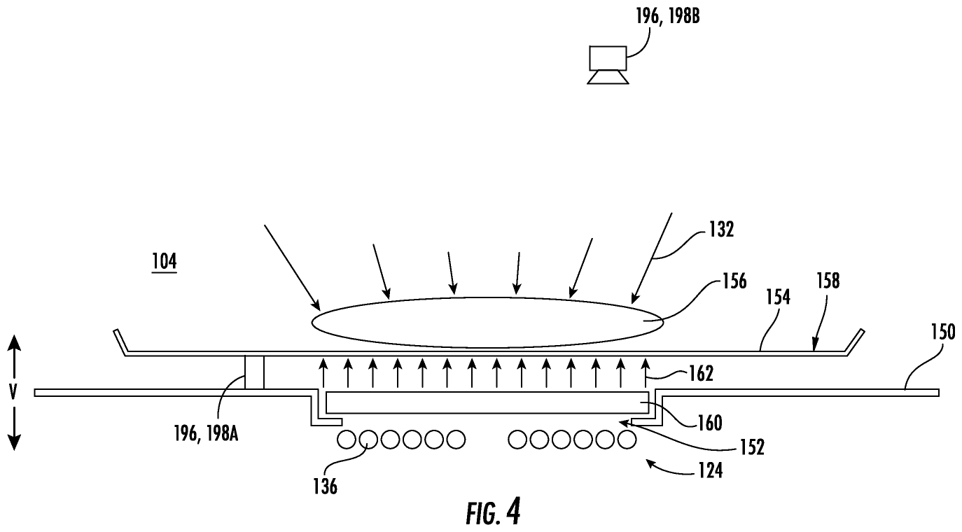

Turning especially to FIG. 4, a schematic sectional view of a bottom portion of cooking appliance 100 is provided. As shown, a bottom wall 150 of inner shell 120 is generally included and beneath which one or more components may be mounted. A tray or platter 154 may be provided above bottom wall 150 and on which a food item 156 may be supported. Either platter 154 or bottom wall 150 may include or define a support pan 158 on which food item 156 may be received. Thus, support pan 158 may be mounted within cooking chamber 104 define the region of cooking appliance 100 onto which a food item 156 is received for cooking.

In some embodiments, a presence detection sensor (PDS) 196 is directed at the support pan 158. Specifically, PDS 196 may be mounted on or within cabinet 102, such as to communicate with at least a portion of cooking appliance 100 within cooking chamber 104 (e.g., at support pan 158). PDS 196 may be in operable (e.g., wired or wireless) communication with controller 118 and configured to detect one or more items (e.g., food item 156) on support pan 158. For instance, PDS 196 may be configured to detect if or when a food item 156 is present on support pan 158.

In certain embodiments, PDS 196 is in mechanical communication with support pan 158. For instance, PDS 196 may be mounted below support pan 158 (e.g., on bottom wall 150 or platter 154). Movement or force of support pan 158 (e.g., as provided by food item 156) may thus be transferred, at least in part, to PDS 196. In certain embodiments, PDS 196 includes a force sensor 198A, which is configured to receive a load thereon (e.g., a force, moment, or pressure load as generated by the presence of food item 156 on support pan 158). Any suitable force sensor 198A may be provided for PDS 196. For instance, the force sensor 198A may include or be provided as a weight/mass sensor (e.g., configured to detect a weight or mass value corresponding to food item 156 on support pan 158), pressure sensor (e.g., configured to detect a pressure value corresponding to pressure generated by the presence of food item 156 on support pan 158), or presence switch (e.g., reed switch, magneto resistive switch, push switch, or pressure switch configured to detect deflection above a set threshold as might be caused by the presence of food item 156 on support pan 158).

In additional or alternative embodiments, PDS 196 is provided as an optical sensor 198B. As illustrated, the optical sensor 198B may be spaced apart from support pan 158. For instance, the optical sensor 198B may be mounted in a top wall of shell (i.e., above support pan 158). Movement or objects (e.g., food item 156) on support pan 158 may thus be sensed at the optical sensor 198B. Any suitable optical sensor 198B may be provided for PDS 196. As an example, the optical sensor 198B may include or be provided as a camera (e.g., video camera or a digital camera) having an electronic image sensor [e.g., a charge coupled device (CCD) or a CMOS sensor] configured to capture one or more images of support pan. As an additional or alternative example, the optical sensor may include or be provided as a break beam sensor configured to direct an optical beam (e.g., laser beam or infrared beam) at support pan, which may be interrupted by a food item 156 and thus detected at the break beam sensor, as would be understood.

In certain embodiments, a one-way field filter 160 is provided between induction heating coil 136 and cooking chamber 104. One-way field filter 160 may limit or restrict passage of microwave radiation or microwaves 132 while permitting the magnetic field 162. The magnetic field 162 generated by induction heating coil 136 may thus be forced to pass through one-way field filter 160 before entering cooking chamber 104.

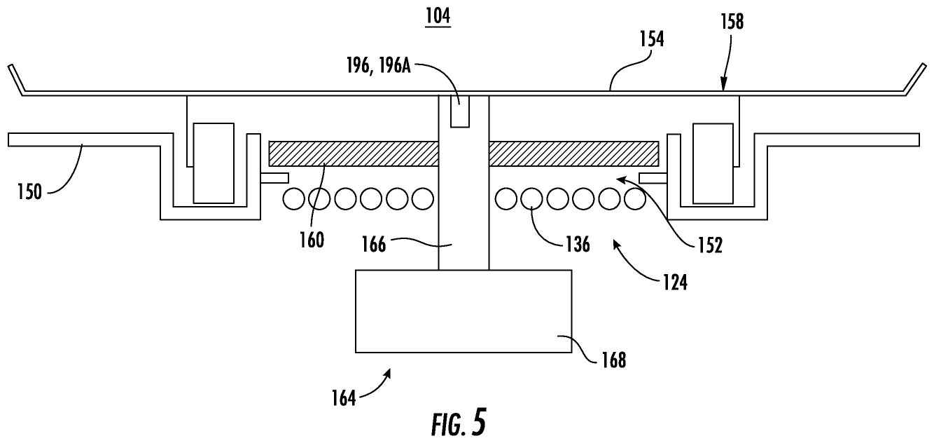

Turning briefly to FIG. 5, in optional embodiments, a turntable assembly 164 is further provided within cabinet 102. Generally, the turntable assembly 164 may include a rotatable a rotatable platter 154 driven by a connected drive rod 166 (e.g., as motivated by a separate motor 168). As shown, platter 154 may be positioned above the one-way field filter 160 within cooking chamber 104. Drive rod 166 may extend (e.g., downward) from platter 154. Optionally, drive rod 166 may extend through one-way field filter 160. Drive rod 166 may connect to a turntable motor 168 held below inner shell 120 or one-way field filter 160. Thus, platter 154 may be coupled to motor 168. Turntable motor 168 may be communicatively coupled to controller 118 and may be any suitable motor 168 for providing rotational motivating force to the platter 154. In some exemplary embodiments, the motor 168 may be a stepper motor. The structure and function of motors are generally understood by those of skill in the art and, as such, are not shown or described in further detail herein for the sake of brevity and clarity. Additionally or alternatively, a position switch or sensor, such as a Hall effect sensor, may be provided in platter 154, drive rod 166, or cabinet 102 such that the angular position of the platter 154 may be known (e.g., based on a signal from the position sensor received by the controller 118).

In some embodiments, a presence detection sensor (PDS 196) is directed at the support pan 158. Specifically, PDS 196 may be mounted on or within cabinet 102, such as to communicate with at least a portion of cooking appliance 100 within cooking chamber 104 (e.g., at support pan 158). PDS 196 may be in operable (e.g., wired or wireless) communication with controller 118 and configured to detect one or more items (e.g., food item 156) on support pan 158. For instance, PDS 196 may be configured to detect if or when a food item 156 is present on support pan 158.

In certain embodiments, PDS 196 is in mechanical communication with support pan 158. For instance, PDS 196 may be mounted below support pan 158 (e.g., on bottom wall 150, platter 154, or drive rod 166). Movement or force of support pan 158 (e.g., as provided by food item 156) may thus be transferred, at least in part, to PDS 196. In certain embodiments, PDS 196 includes a force sensor 198A, which is configured to receive a load thereon (e.g., a force, moment, or pressure load as generated by the presence of food item 156 on support pan 158). Any suitable force sensor 198A may be provided for PDS 196. For instance, the force sensor 198A may include or be provided as a weight/mass sensor (e.g., configured to detect a weight or mass value corresponding to food item 156 on support pan 158), pressure sensor (e.g., configured to detect a pressure value corresponding to pressure generated by the presence of food item 156 on support pan 158), or presence switch (e.g., reed switch, magneto resistive switch, push switch, or pressure switch configured to detect deflection above a set threshold as might be caused by the presence of food item 156 on support pan 158).

In additional or alternative embodiments, PDS 196 is provided as an optical sensor 198B. As illustrated, the optical sensor 198B may be spaced apart from support pan 158. For instance, the optical sensor 198B may be mounted in a top wall of inner shell 120 (i.e., above support pan 158). Movement or objects (e.g., food item 156) on support pan 158 may thus be sensed at the optical sensor 198B. Any suitable optical sensor 198B may be provided for PDS 196. As an example, the optical sensor 198B may include or be provided as a camera (e.g., video camera or a digital camera) having an electronic image sensor [e.g., a charge coupled device (CCD) or a CMOS sensor] configured to capture one or more images of support pan 158. As an additional or alternative example, the optical sensor 198B may include or be provided as a break beam sensor configured to direct an optical beam (e.g., laser beam or infrared beam) at support pan 158, which may be interrupted by a food item 156 and thus detected at the break beam sensor, as would be understood.

Now that the construction of cooking appliance 100 and the configuration of controller 118 according to exemplary embodiments have been presented, exemplary methods (e.g., method 600) of operating a cooking appliance will be described. Although the discussion below refers to the exemplary method 600 of operating a cooking appliance 100, one skilled in the art will appreciate that the exemplary method 600 is applicable to the operation of a variety of other was cooking appliances, such as a stand-alone microwave appliance, toaster oven, air fryer, etc. In exemplary embodiments, the various method steps as disclosed herein may be performed (e.g., in whole or part) by controller 118.

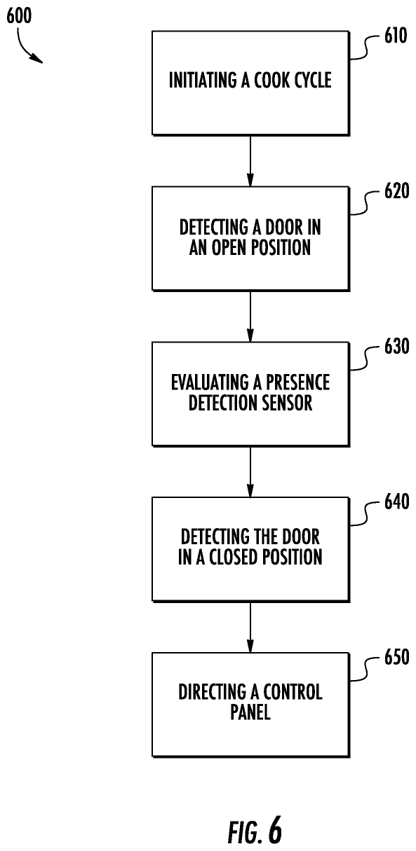

FIG. 6 depicts steps performed in a particular order for purpose of illustration and discussion. Those of ordinary skill in the art, using the disclosures provided herein, will understand that (except as otherwise indicated) method 600 can be modified, adapted, rearranged, omitted, interchanged, or expanded in various ways without deviating from the scope of the present disclosure.

Advantageously, methods in accordance with the present disclosure may automatically (e.g., without direct user input) determine if an interrupted cooking operation should continue or, alternatively, that a user's attention is needed. Additionally or alternatively, methods in accordance with the present disclosure may automatically tailor alerts and account for a user's intervention.

At 610, the method 600 includes initiating a cooking cycle. For instance, 610 may include activating one or more of the cooking modules to heat a food item within the cooking chamber. As would be understood, initiation of the cooking cycle may be prompted by one or more user inputs (e.g., on the control panel), which may specify the desired time or duration for the cooking cycle as well as a moment in which the cooking cycle is desired to start (e.g., by pressing a “START” button). Additionally or alternatively, a user may select one or more power settings (e.g., as a percentage of cooking power output). Further additionally or alternatively, and as would further be understood, the one or more user inputs may specify a conditional or automatic cooking cycle, wherein the duration of the cooking cycle is conditional on one or more detected signals from one or more sensors (e.g., steam or temperature sensors) mounted within the cooking appliance, as would be understood.

At 620, the method 600 includes detecting the door in an open position following 610. In some embodiments, 620 occurs during the cooking cycle (e.g., while one or more of the cooking modules is actively heating a food item within the cooking chamber). In additional or alternative embodiments, 620 includes receiving one or more open signals from the door sensor. As would be understood, such signals may generally correspond to the door being, at least, in a position other than the closed position. Thus, 620 may include determining the door is no longer in the closed position. Such signals and subsequent determinations may be made, for instance, in response to a user manually opening the door or directing the door to open during the cooking cycle of 610.

In some embodiments, the method 600 includes halting the active cooking modules (or all cooking modules uniformly) in response to 620. Moreover, the cooking modules may be restricted from activating or otherwise generating heat (e.g., while the door remains open or otherwise not in the closed position). Thus, opening the door may stop (e.g., temporarily pause) the cooking cycle of 610.

At 630, the method 600 includes evaluating the presence detection sensor. In particular, it may be determined if one or more signals are received from the presence detection sensor to indicate if one or more food items have been moved from the support pan. Thus, 630 may include either determining an item-absence state indicating a food item has been moved (e.g., removed and is no longer present at the support pan) or, alternatively, determining an occupied state indicating a food item is present (e.g., on the support pan).

In some embodiments, determining an item-absence state includes detecting a reduction in weight (e.g., based on one or more force signals received from the force sensor). The reduction in weight may be, for instance, a reduction in a weight value (e.g., in comparison to a detected weight value prior to 630) or a switch signal (e.g., indicating a switch is disengaged or not depressed beyond a set threshold, as would otherwise occur in the presence of a food item on the support pan).

In additional or alternative embodiments, determining an item-absence state is based on one or more received optic signals from the optical sensor. As an example, an image may be captured and analyzed to determine that no food item is detected within the captured image. In other words, an algorithm attempting to recognize one or more items on the support panel may be applied to a captured image. Attempts at recognizing items may be performed by edge matching, divide-and-conquer search, greyscale matching, histograms of receptive field responses, or another suitable routine (e.g., executed at the controller based on one or more captured images from the camera), as would be understood. As an additional or alternative example, one or more signals from the break beam sensor may be received and analyzed to determine that the optical beam is not broken and, thus, no food item is present on the support pan.

In some embodiments, determining an occupied state includes detecting a maintenance of or increase in weight (e.g., based on one or more force signals received from the force sensor). The maintenance of or increase in weight may be, for instance, a maintenance of or increase in a weight value (e.g., in comparison to a detected weight value prior to 630) or a switch signal (e.g., indicating a switch is engaged or pressed beyond a set threshold corresponding the presence of a food item on the support pan).

In additional or alternative embodiments, determining an occupied state is based on one or more received optic signals from the optical sensor. As an example, an image may be captured and analyzed to determine that one or more food items are detected within the captured image. In other words, an algorithm recognizing one or more items on the support panel may be applied to a captured image. Recognizing items may be performed by edge matching, divide-and-conquer search, greyscale matching, histograms of receptive field responses, or another suitable routine (e.g., executed at the controller based on one or more captured images from the camera), as would be understood. As an additional or alternative example, one or more signals from the break beam sensor may be received and analyzed to determine that the optical beam is broken and, thus, a food item is present on the support pan.

In certain embodiments, 630 follows 620. For instance, 630 may be in response to 620. Additionally or alternatively, 630 may be performed to evaluate the presence detection sensor according to a set schedule.

At 640, the method 600 includes detecting the door in the closed position. In some embodiments, 640 includes receiving one or more closed signals from the door sensor. As would be understood, such signals may generally correspond to the door being in the closed position. Thus, 640 may include determining the door is again in the closed position. Such signals and subsequent determinations may be made, for instance, in response to a user manually closing the door or directing the again close.

Generally, 640 follows 620. In certain embodiments, 640 follows 630. Alternatively, 640 may precede 630. Optionally, 630 may be in response to 640.

At 650, the method 600 includes directing a control panel (e.g., based on 630). In particular, one or more communication or alert features, such as the display or speaker, may be controlled based on the evaluation at 630. Different alert actions (e.g., active alerts/messages or lack thereof) may be dependent on whether a food item is determined to be present.

In some embodiments, 650 includes comprises disabling a programmed alert (e.g., in response to determining an item-absence state). The programmed alert may generally correspond to an alert action (e.g., message presented on the display or sound notifications, such as reminders for a user to continue a cooking action). Thus, 650 may include restricting or preventing one or more alert actions at the control panel. Such restrictions may be in response to determining an item-absence state at 630. As a result, removal of a food item may notably cause the appliance to automatically halt notifications. Additionally or alternatively, the cooking cycle may be cleared or otherwise directed to end (e.g., prior to a set end condition, such as the expiration of a user-set time).

In certain embodiments, 650 includes comprises enabling a programmed alert (e.g., in response to determining an occupied state). The programmed alert may generally correspond to an alert action (e.g., message presented on the display or sound notifications, such as reminders for a user to continue a cooking action). Thus, 650 may include permitting or initiating one or more alert actions at the control panel. Such an initiation may be in response to determining an occupied state at 630. As a result, the presence of a food item on the support may notably cause the appliance to continue notifications. Additionally or alternatively, the cooking cycle may be maintained or reinstated or otherwise directed to continue (e.g., to a set end condition, such as the expiration of a user-set time).

In certain embodiments, 650 follows 640. For instance, 650 may be in response to 620. Thus, after the door is returned to the closed position, 650 may be performed to control the control panel in accordance with whether a food item remains within the cooking chamber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cabinet defining a cooking chamber;
a door movably mounted to the cabinet to selectively restrict access to the cooking chamber;
a control panel attached to the cabinet;
a microwave module mounted within the cabinet, the microwave module positioned and configured for delivering microwave energy into the cooking chamber;
a support pan mounted within the cooking chamber to receive food items thereon;
a presence detection sensor directed at the support pan and configured to detect one or more food items on the support pan; and
a controller in operable communication with the presence detection sensor and the control panel, the controller configured to direct an appliance operation comprising:
detecting the door in an open position,
evaluating the presence detection sensor,
detecting the door in a closed position following evaluation of the presence detection sensor, and
directing the control panel according to the evaluation in response to detecting the door in the closed position.

2. The cooking appliance of claim 1, wherein the presence detection sensor is in mechanical communication with the support pan.

3. The cooking appliance of claim 2, wherein the presence detection sensor comprises a force sensor to receive a load thereon.

4. The cooking appliance of claim 1, wherein the presence detection sensor comprises an optical sensor.

5. The cooking appliance of claim 4, wherein the presence detection sensor comprises a camera or a break beam sensor.

6. The cooking appliance of claim 1, wherein evaluating the presence detection sensor comprises determining an item-absence state.

7. The cooking appliance of claim 6, wherein directing the control panel comprises disabling a programmed alert.

8. The cooking appliance of claim 7, wherein evaluating the presence detection sensor comprises detecting a reduction in weight.

9. The cooking appliance of claim 1, wherein evaluating the presence detection sensor comprises determining an occupied state.

10. The cooking appliance of claim 9, wherein directing the control panel comprises enabling a programmed alert.

11. A method of operating a cooking appliance comprising a cabinet, a door movably mounted to the cabinet, a presence detection sensor, and a control panel, the method comprising
detecting the door in an open position;
evaluating the presence detection sensor;
detecting the door in a closed position following evaluation of the presence detection sensor; and
directing the control panel according to the evaluation in response to detecting the door in the closed position.

12. The method of claim 11, wherein the presence detection sensor is in mechanical communication with a support pan within the cabinet of the cooking appliance.

13. The method of claim 12, wherein the presence detection sensor comprises a force sensor to receive a load thereon.

14. The method of claim 11, wherein the presence detection sensor comprises an optical sensor.

15. The method of claim 14, wherein the presence detection sensor comprises a camera or a break beam sensor.

16. The method of claim 11, wherein evaluating the presence detection sensor comprises determining an item-absence state.

17. The method of claim 16, wherein directing the control panel comprises disabling a programmed alert.

18. The method of claim 17, wherein evaluating the presence detection sensor comprises detecting a reduction in weight.

19. The method of claim 11, wherein evaluating the presence detection sensor comprises determining an occupied state.

20. The method of claim 19, wherein directing the control panel comprises enabling a programmed alert.
